(19) United States
(12) Patent Application Publication
(10) Pub. No.: US 2010/0265088 A1
(43) Pub. Date: Oct. 21, 2010

(54) C & C construction safety light

(76) Inventor: Jackie Doyle Creech, JR., Pekin, IL (US)

Correspondence Address: Jackie D. Creech, 14320 S 14th ST, Pekin, IL, 61554, US

(21) Appl. No.: 12/386,626

(22) Filed: Apr. 21, 2009

(51) Int. Cl. G09F 9/33

(52) U.S. Cl. 340/815.45

(57) ABSTRACT

The C & C construction portable flashing flagger safety lights are designed as an innovative new safety product These lights are very different than other lights. They are manufactured solely for construction flagger signs and school crossing guard signs.

The lights are made so they can be removed from one sign and installed onto a different sign. The lights are unique because they can be transferred to other signs. The lights are not made as part of the sign. These lights are only used on flagger signs and school crossing guard signs. The lights placed on either a flagger or school crossing guard sign will help drivers be prepared for different driving conditions. C & C construction portable flashing flagger safety lights will have two lights for each sign. On the stop side of the sign there are two flashing lights. One light will be placed at the top of the sign and the other flashing light will be placed at the bottom of the sign. The same sign on the slow side of the sign will have the same placement of the lights, but the flashing lights will be yellow on this side of the sign. Please keep in mind that there are only two units for the flagger sign. Each unit will have one side that flashes red for the stopping of traffic. The other side of the light will be flashing yellow for the slow side of the sign. The school crossing sign will only require one C & C construction portable flashing flagger safety light This light is a smaller version but is made identical to the larger size. This light will be mounted on the topside of the sign. Again one side will be flashing red to stop traffic. The other side will be flashing yellow to make drivers aware of the children. These new portable flashing safety lights will save lives of both highway workers, and children crossing streets while going to and from school.

The C & C construction portable flashing flagger safety lights will clamp onto the portable flagger and school crossing guard signs with the special abrasive material. These lights will be able to be used on all flagger and school crossing guard signs that are in use today. Please keep in mind that these signs do not have lights on them. The way that most of the workers get the attention of drivers is to wave the sign at them. This is very dangerous for the worker, children and the drivers. The C & C construction portable flashing flagger safety lights installed on these signs will make it much safer for all who work on roads and help direct traffic for all purposes.

### BACKGROUND OF INVENTION

The present invention is in the technical field of highway construction safety. More particularly, the present invention is in the technical field of highway, road and school crossing safety.

### SUMMARY OF THE INVENTION

The present invention is a highway, Road and school safety device. It will help limit injuries and save lives, of highway, road flaggers and school crossing guards. This invention is portable and removable allowing it to be used on different flagger and school crossing portable signs. This device is portable and removable making it a new product Signs that are in use today can use this portable and removable safety device. Saving tax payers millions of dollars.

The present invention is a highway flagger safety device that can be removed and transferred onto other flagger or school crossing signs. It is also solar charged and can be used at night and times when it is not clear or foggy outside and or the weather is bad.

### BRIEF DESCRIPTION OF DRAWING

FIG. 1 is a perspective view of one side view of the invention.

FIG. 2 is a perspective top and side view.

FIG. 3 is a perspective view of the opposite side of the invention.

FIG. 4 is a perspective view of one outer side of the invention with measurements and features of the device.

FIG. 5 is a perspective view of the invention showing measurements and features of the device. The construction details may be of injection molding or of any sufficient rigid and strong material such as high strength plastic.

FIG. 6 is a perspective view showing certain on/off switches of the device.

### DETAILED DESCRIPTION OF THE INVENTION

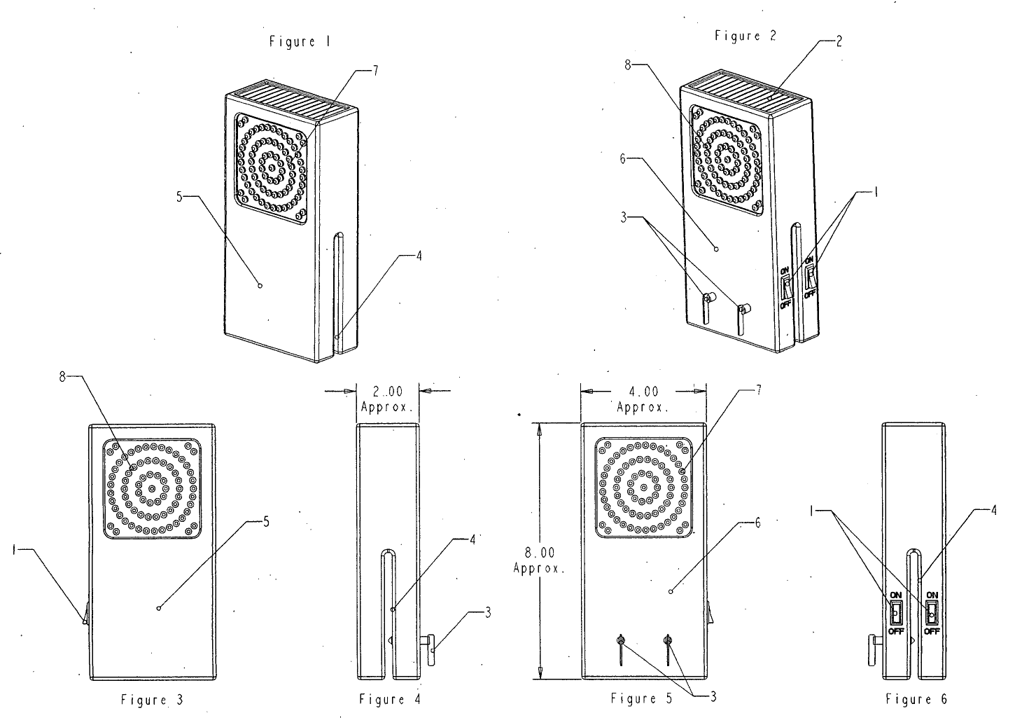

FIG. 1 number 7 showing yellow flashing caution led lights.

FIG. 1 number 5 showing yellow side of device matching the color of a highway construction flagger sign.

FIG. 1 number 4 showing the opening so the portable and removable device will slide onto a flagger or school crossing sign.

### DETAILED DESCRIPTION OF THE INVENTION

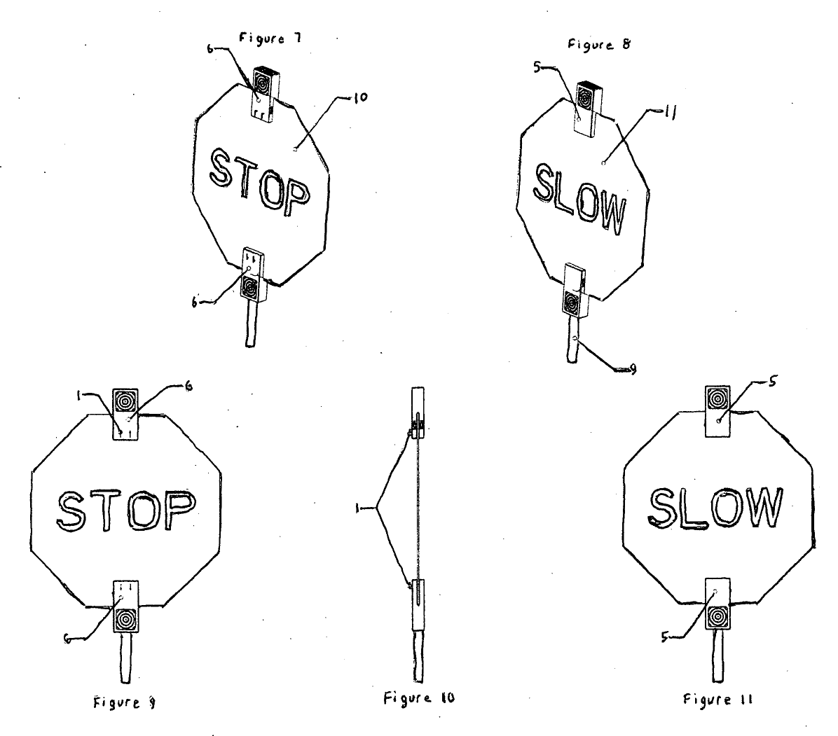

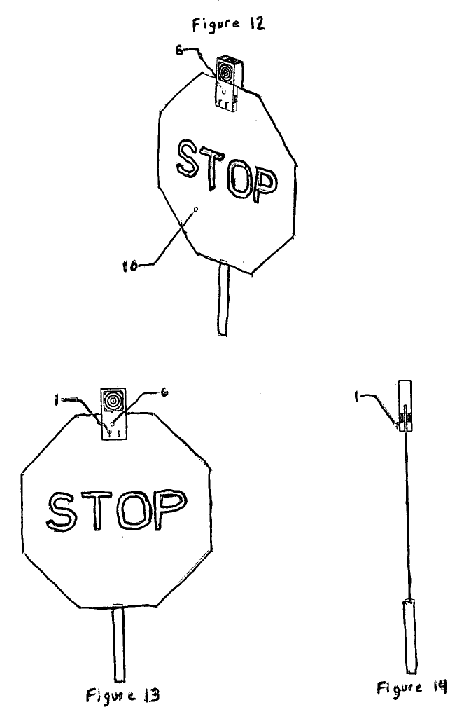

FIG. 2 number 1 showing manual on/off switch that operates one or both sides of the portable and removable construction flagger safety device.

FIG. 2 number 2 showing a small rechargeable solar panel that charges the construction and school crossing device.

FIG. 2 number 3 showing clamps that firmly hold portable and removable construction and school crossing safety device.

FIG. 2 number 6 showing red stop side of the device that matches the color of the portable and removable construction flagger and school crossing safety device.

FIG. 2 number 8 showing red flashing stop led light bulbs that flash while the construction flagger and school crossing guard is directing traffic.

### DETAILED DESCRIPTION OF THE INVENTION

FIG. 3 number 1 showing manual on/off switches that turn flashing led bulbs on or off for either side of the device.

FIG. 3 number 5 showing yellow or caution side of the portable or removable flashing construction safety device for highway flaggers or school crossing signs.

FIG. 3 number 8 showing flashing led caution lights for the slow side of the portable or removable construction flagger and school crossing signs.

### DETAILED DESCRIPTION OF THE INVENTION

FIG. 4 number 3 showing clamps that hold portable or removable Construction safety device onto the flagger or school crossing hand held sign.

FIG. 4 number 4 showing the opening of the portable or removable construction safety device that slides onto the flagger or school crossing portable hand held signs. The clamp is tightened to hold the device firmly onto the portable signs mentioned. This also shows that the portable and removable construction flashing device is approximately two inches in depth.

### DETAILED DESCRIPTION OF THE INVENTION

FIG. 5 number 3 showing clamps that hold the construction flagger And school crossing guard sign firmly onto the portable signs.

FIG. 5 number 6 showing the side view of the red color that will match the stop side of the sign.

FIG. 5 number 7 showing the red flashing led lights that will be mounted on the stop side of the sign. This also shows the size in inches that the device will be manufactured. Size eight inches tall four inches in width.

### DETAILED DESCRIPTION OF THE INVENTION

FIG. 6 number 1 showing the on/off switch that allows the Device to be turned on and off.

FIG. 4 number 4 showing the opening that allows the portable and removable device to be installed onto a flagger or school crossing hand held sign.

### DETAILED DESCRIPTION OF THE INVENTION

FIG. 7 number 6 showing the red color of the device that matches the stop side of the flagger and school crossing stop sign.

FIG. 7 number 10 showing the red color device of the stop side of the flagger sign. The safety has to be the same color on both sides to match the color of the flagger and school crossing guard sign by state and federal law.

### DETAILED DESCRIPTION OF THE INVENTION

FIG. 8 number 5 showing the yellow color of the device that matches the slow side of the sign.

FIG. 8 number 9 showing the hand held flagger pole that the sign and device is mounted on. This is what the flagger holds while directing traffic around highway, road work and school crossings.

FIG. 8 number 11 showing the yellow color of the slow side of the flagger sign.

### DETAILED DESCRIPTION OF THE INVENTION

FIG. 9 number 1 showing clamps that hold device onto the flagger sign.

FIG. 9 number 6 showing the color red that matches the color of the flagger stop side of the sign.

FIG. 9 number 6 showing the color red that matches the color of the flagger stop side of the sign.

### DETAILED DESCRIPTION OF THE INVENTION

FIG. 10 number 1 showing clamps on both devices that hold the device firmly onto the portable flagger sign.
number 1 each portable flagger sign will use two devices on each flagger sign. The solar rechargeable device will have flashing red led lights on the stop side of the device. On the slow side of the device it will have yellow flashing led lights. All flagger signs will require two separate devices. One will be mounted on top of the flagger sign. And one will be mounted at the bottom of the flagger sign. Each device will have a stop side and a slow side.
The school crossing hand held sign will only require one device. This device only will have red flashing led bulbs on both sides. The school device will only be used to stop traffic from both directions while the school children cross the road. The device will be mounted on top of the hand held sign.

### DETAILED DESCRIPTION OF THE INVENTION

FIG. 11 number 5 showing the yellow color of the device that matches the slow side of the flagger sign.

### DETAILED DESCRIPTION OF THE INVENTION

FIG. 12 number 6 showing the red side of the portable red hand held school stop sign with the device mounted on top. The flagger sign is also portable and held by hand. The school crossing signs only use one device that is the colored red on both sides of the device. The school crossing hand held sign has stop on both sides. The reason the devices are colored red and yellow for the construction flagger signs and the school hand held signs with the device colored red on both sides. It is because the federal and state government require that the construction flagger sign and the school hand held sign have a certain amount of color on every sign that is in use.

FIG. 12 number 10 showing one side of the hand held school crossing sign that is red in color. Both sides of the school crossing signs are color red for all school hand held crossing stop signs.

### DETAILED DESCRIPTION OF THE INVENTION

FIG. 13 number 6 showing the red color that matches the stop side of the school hand held school crossing sign Both sides of the school hand held stop sign have red flashing led lights.
number 1 showing the clamps that hold the device firmly onto the hand held school crossing guard atop sign. The clamps on the portable and removable construction flagger safety device use the same type of clamps to secure the device to the sign. These clamps are made so that the device can be easily transferred from one flagger sign to a different sign. The same clamps are used on the hand held school crossing safety device. So they also can be transferred from on sign to another sign quick and easy.

### DETAILED DESCRIPTION OF THE INVENTION

FIG. 14 number 1 showing safety device clamped onto the top of a hand held school crossing guard safety sign. Only one flashing safety device is needed for the school crossing sign. This device is mounted on top of the hand held sign, both sides of the sign and the safety device are identical. The safety device has a solar panel made into the device. This will keep the rechargeable battery charged for days when bad weather such as rain, fog, night time and etc. So that work can continue on days such as these.

### THE ADVANTAGES OF THE INVENTION

This invention will reduce highway and road work injuries and save human lives.

The invention is a very light weight safety device that can be installed onto different hand held construction flagger signs and school crossing signs. It also can be used on the same types of signs with very little time and effort. This is one of many advantages. The portable and removable device can be used on all construction flagger signs that all companies use to keep their employees safe. The device will add much needed safety for all workers that work in and around traffic. This will help the workers be safe and also feel safe while doing their very dangerous jobs. This safety device can be put into service right now on existing construction flagger and school crossing guard signs. The results will be seen as quick as this new portable and removable safety device is put in service. This safety device is solar charged with a rechargeable battery that is built into the safety device. This enables the user to transfer the device from one sign to a different sign. This device will make the work zone and school children crossings much safer. People driving will see this portable and removable safety device way before they get to close to workers or school children, not giving them time to react by using their breaks. This is where the highway, road workers and children lives will be saved from people driving and not seeing the workers on the roads. Businesses and schools have signs in use now, but not with the new safety device I have. The advantages of using this portable and removable safety device is very clear. What is a bigger advantage then to save a humans life. This safety device can start now helping drivers see highway and road work well before they see a worker holing a portable sign. People driving at the time when school starts and ends each day will be made much more aware that they need to stop while children of all ages cross the road while the school crossing guard stops the traffic. Again the drivers will see the portable and removable safety device flashing red lights. Another advantage besides the most important of saving human lives. This safety device can be very easily taken off one portable flagger sign or school crossing sign, and easily installed on a different portable sign. We owe our workers the safety they deserve, and this device will guarantee that safety. Each safety device is self contained. This helps while it is installed and keeps it from having wires or other parts exposed. The device is built to handle rough use and is made of quality parts.
Thank You,

1. I Jackie Doyle Creech file claim to the C & C construction portable flashing flagger safety lights. My Claim is that I have the rights to the portable and removable flashing safety referred to as the C & C construction portable flashing flagger safety lights. These lights are only used for construction flagger signs and all work that requires a portable stop and slow sign. A school crossing guard will also be able to use a smaller version of the portable flashing safety light The flashing lights will be powered by both solar and a rechargeable 9 volt battery (or comparable). Please refer to drawings attached. Each light has a manual on/off switch and the material of which the light is manufactured from is injection-molding plastic. The lights will be very durable and light in weight. Making this light a high quality product that will help save lives. Each light contains fifty to sixty five LED bulbs making this light visible up to one quarter of a mile. This amount of visibility is made possible from the LED bulbs and the special inward construction of the light housing case.
Each C & C construction portable flashing flagger safety lights is painted the same color of the sign that it will be installed on. The two colors of the signs are red and yellow. The reason that the lights are colored is so it matches the sign. In most states there is a law that the flaggers signs have to have a certain amount of red and yellow color on each side of the sign. The light housing case has a built in clamp with a special abrasive material to ensure that the lights are secure. This is what holds the light firmly onto the sign; it also makes for very easy removal.
C & C construction portable flashing flagger safety lights will make the person that is holding the portable flagger sign much safer along with the workers who are working at the work zone. This light will save lives and make drivers more aware that there is a work zone ahead. Also it will make school crossing areas much safer.
